(19) United States
(12) Patent Application Publication
(10) Pub. No.: US 2003/0121106 A1
(43) Pub. Date: Jul. 3, 2003

(54) Process for cleaning a substrate

(75) Inventors: Vijaya Milind Bargaje, Bangalore (IN); Paul Johan Birker, Vlaardingen (NL); Cornelis Gerhard van Kralingen, Vlaardingen (NL); Glyn Roberts, Bangalore (IN); Pieter van der Vlist, Vlaardingen (NL); Vidur Behal, Mumbai (IN)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/299,516

(22) Filed: Nov. 19, 2002

(30) Foreign Application Priority Data
Nov. 20, 2001 (IN) 1100/MUM/01
Nov. 23, 2001 (GB) 0128139.3

(51) Int. Cl. B08B 3/12

(52) U.S. Cl. 8/137; 8/142; 134/1; 134/26; 134/34

(57) ABSTRACT

A process of cleaning a substrate, the process comprising the steps of contacting a substrate with a composition comprising at least two liquids mutually presenting a liquid-liquid interface with an interfacial tension of at least 5 mN/m and agitating the substrate and/or composition whilst they are in mutual contact, wherein the composition and/or the substrate are also subjected to ultrasound before and/or during the agitation step.

### TECHNICAL FIELD

The invention relates to a method or a process of cleaning a substrate.

### BACKGROUND AND PRIOR ART

Conventionally, in household cleaning, soiled substrates such as textile fabrics or hard surfaces are cleaned using water and a detergent composition, which is known as wet cleaning. Surfactants in the detergent adsorb on both substrate and soil and thereby reduce the respective interfacial energies and this facilitates removal of soil from the fabric.

Fabrics may also be cleaned by a process called dry cleaning where organic non-polar solvents are used, generally aided by a surfactant. During dry cleaning, when a surfactant is used, a maximum of about 10% of water is also used along with the solvent system in order to facilitate the removal of water soluble stains. In dry cleaning, soil removal can be achieved by a small reduction in interfacial tension. The organic solvent helps in removal of oily soil in the presence of detergents and the particulate soil is largely removed by providing agitation.

Regardless of the type of solvent used, which may be water or an organic solvent, agitation of garments in the cleaning medium is essential to accelerate the removal of soluble soil or insoluble, particulate soil.

U.S. Pat. No. 4,115,061 (Henkel) discloses a method of cleaning using a combination of an organic solvent and a concentrated aqueous detergent solution for cleaning soiled textiles.

U.S. Pat. No. 4,378,968 discloses a process for reducing soil redeposition onto textiles in order to limit the phenomenon of ‘greying’ of the textiles by incorporating at least one primary or secondary alcohol as an anti redeposition adjuvant into the perchloroethylene solvent during dry cleaning.

GB-A-1 493 619, GB-A-1 470 332 and GB-A-1 3122 84 disclose a method of treating fabrics in a two-phase liquid comprising a conventional dry-cleaning liquid as a major portion and a hydrogen peroxide bleaching solution as a minor portion. Typically the peroxide solution is present at less than 10 wt % of the dry-cleaning liquid (approximately 9 wt % of the two-phase liquid) and preferably less than 5 wt % of the dry-cleaning fluid (approximately 4.75 wt % of the two-phase liquid).

EP-A-0 075 546 discloses a water-in-perchloroethylene microemulsion containing 2-6 wt % emulsifier (surfactant) and 0.2-4 wt % solubilising agent included in order to reduce interfacial tensions to stabilise the emulsion thus formed.

WO-A-97/19164 discloses a liquid fabric washing composition in three phases which comprises, among other ingredients, 1 to 15 wt % of non-polar liquid, 55 to 95wt % of a polar solvent, preferably water, and 1 to 23 wt % of a low molecular weight amphiphilic compound. The amphiphilic compound reduces the interfacial tensions to less than 10⁻³ mN/m to enable a single continuous phase to be formed with minimal mechanical agitation.

It has now been found that cleaning a substrate using a composition comprising at least two immiscible liquids, while providing agitation, results in superior cleaning as compared to conventional methods, especially when the liquids are subjected to ultrasound.

### DEFINITION OF THE INVENTION

A process of cleaning a substrate, the process comprising the steps of contacting a substrate with a composition comprising at least two liquids mutually presenting a liquid-liquid interface with an interfacial tension of at least 5 mN/m and agitating the substrate and/or composition whilst they are in mutual contact, wherein the composition and/or the substrate are also subjected to ultrasound before and/or during the agitation step.

### DETAILED DESCRIPTION OF THE INVENTION

The process of the invention utilises a composition for cleaning a substrate, comprising at least two immiscible liquids with a high interfacial tension.

Preferably the interfacial tension (IFT) of at least one liquid-liquid interface in the composition is at least 5 mN/m, preferably at least 8 mN/m, and more preferably at least 10 mN/m. Suitably the interfacial tension is at least 15 mN/m, advantageously at least 20 mN/m and desirably at least 35 mN/m. Interfacial tension may be measured using various techniques, such as sessile drop, pendant drop, spinning drop, drop volume or Wilhelmy plate method.

For the purposes of the present invention, interfacial tension is measured by the Wilhelmy plate method, using a Kruss Processor Tensiometer K12, at 25° C.

For some systems, the interfacial tension may change whilst undergoing shearing forces typically encountered in a wash process. It is customary to refer to the interfacial tension under these conditions as a “dynamic interfacial tension” (DIFT) and may be measured by a maximum bubble pressure technique.

In a preferred embodiment of the present invention, a fatty acid or fatty amine with a carbon chain length of C₁₂ to C₂₂ maybe added to the composition. In another preferred embodiment of the present invention, builders may be added to the composition.

In still another preferred embodiment of the present invention, mineral salts may be added to the composition.

It is possible to incorporate other conventional detergent ingredients such as anti-redeposition agents, soil release polymers, hydrotropes, enzymes, bleaches, fluorescers and perfumes in the composition. However, it is preferred that the composition is free of hydrogen peroxide or water soluble hypochlorites and is more preferably free of bleaching compounds.

In principle, limited amounts of cyclic, linear or branched surfactants known in the art may be present provided that the interfacial tension is not reduced below 5 mN/m, preferably not below 10 mN/m. Preferred surfactants include nonionic, anionic, cationic and zwitterionic surfactants. Preferably, the composition comprises less than 0.9 wt % of surfactant, more preferably less than 0.4 wt %, even more preferably less than 0.1 wt %, even more preferably less than 0.05 wt % of a surfactant by weight of the total composition. However, the composition is preferably free of surfactant.

The invention will now be described in greater detail with reference to immiscible liquid compositions for cleaning fabric.

Liquid Components

Preferably, one of the liquids is more polar than the other. Although the term solvent or liquid is used in the singular, it should be noted that a mixture of solvents or liquids may also be used. Thus, the singular should be taken to encompass the plural, and vice versa.

More polar liquid components that may be used include water, alcohols, ethers, glycol ethers, ketones, phenols, aldehydes, organic sulphur compounds and nitrogen-containing compounds such as nitrates or nitriles. Preferable polar liquids include ethanol, methanol, monoethanol amine, water and mixtures thereof. Less polar liquids which may be used include esters, hydrocarbons, paraffins, aromatic solvents, halogenated solvents, heterocyclic solvents, terpenes, mineral oils and silicone oils. Mixtures of any of these can be used wherein at least one liquid-liquid interface exists and the interfacial tension is at least 5 mN/m, preferably at least 10 mN/m, more preferably at least 15 mN/m, still more preferably at least 20 m/Nm, still more preferably at least 30 mN/m, most preferably at least 35 mN/m.

Preferably the amount of the most polar liquid in the composition is from 1 to 90% by volume, preferably from 1% to 90%, more preferably from 25% to 90%, still more preferably from 40% to 90% and most preferably from 60% to 90% expressed as volume/volume % of the total composition. Preferably the most polar liquid is water and preferably the least polar liquid is selected from hydrocarbons such as C₉-C₂₀ alkanes petroleum ether, cycloalkanes such as cyclohexane, siloxanes, liquid carbon dioxide, halogenated solvents, preferably selected from perchloroethylene, fluorinated solvents, especially hydrofluorether, phthalates, esters, terpenes and mixtures thereof.

It is also preferred to match the densities of the more and less polar liquids, e.g. to within 10%, preferably within 5%, more preferably within 1% of the density of the most polar liquid. Preferably, the less polar liquid has a density of within 10% or less, preferably within 5% or less, most preferably within 1% or less of that of the most polar of the at least two liquids. Preferably, densities of the liquids are within 10%, preferably 5%, more preferably by 1% of that of water. For example, the most polar liquid has a density of within 10% or less, preferably within 5% or less, most preferably within 1% or less of that of the water, with or without any solutes. Density matching of the more and less polar liquids can be effected by using a mixture of two or more liquid components to form the less polar and/or more polar liquids. The same principles apply when there are 3 or more immiscible liquids.

More details of organic solvents of the aforementioned and other classes which are useable as all or part of the less polar liquid are as follows:

Fluoro Solvents:

These are usually non-flammable, non-chlorine containing organic solvents. A mixture of such solvents may also be used. Because of the typical environmental problems associated with chlorine containing solvents, the solvent preferably does not contain Cl atoms. In addition, the solvent should not be flammable such as petroleum or mineral spirits are. The term non-flammable is as defined below. One preferable class of solvents is a fluorinated organic dry cleaning solvent including hydrofluorocarbon (HFC), hydrofluoroether (HFE) or mixtures thereof. Another class of suitable solvents are siloxanes (see below).

The most desirable solvents are non-ozone depleting and a useful common definition for the ozone depleting potential is defined by the Environmental Protection Agency in the USA: the ozone depleting potential is the ratio of the impact on ozone of a chemical compared to the impact of a similar mass of CFC-11. Thus, the ODP of CFC-11 is defined to be 1.0.

Hydrofluorocarbons

One preferred hydrofluorocarbon solvent is represented by the formula CxHyF(2x+2−y), wherein x is from 3 to 8, y is from 1 to 6, the mole ratio of F/H in the hydrofluorocarbon solvent is greater than 1.6.

Preferably, x is from 4 to 6 and most preferred x is 5 and y is 2.

Especially suitable are hydrofluorocarbon solvents selected from isomers of decafluoropentane and mixtures thereof. In particular useful is 1,1,1,2,2,3,4,5,5,5-decafluoropentane. The E.I. Du Pont De Nemours and Company markets this compound under the name Vertrel XF™.

Hydrofluoroethers

Hydrofluoroethers (HFEs) are generally low polarity chemical compounds minimally containing carbon, fluorine, hydrogen, and catenary (that is, in-chain) oxygen atoms. HFEs can optionally contain additional catenary heteroatoms, such as nitrogen and sulphur. HFEs have molecular structures which can be linear, branched, or cyclic, or a combination thereof (such as alkylcycloaliphatic), and are preferably free of ethylenic unsaturation, having a total of about 4 to about 20 carbon atoms. Such HFEs are known and are readily available, either as essentially pure compounds or as mixtures.

HFEs can be relatively low in toxicity, are claimed to have zero ozone depletion potential, have short atmospheric lifetimes, and have low global warming potentials relative to chlorofluorocarbons and many chlorofluorocarbon substitutes. Furthermore, HFEs are listed as non volatile organic compounds by the EPA. Volatile organic compounds are considered to be smog precursors.

Preferred hydrofluoroethers can have a boiling point in the range from about 40° C. to about 275° C., preferably from about 50° C. to about 200° C., even more preferably from about 50° C. to about 121° C. It is very desirable that the hydrofluoroether be non-flammable. In general, decreasing the F/H ratio or decreasing the number of carbon-carbon bonds each decreases the flash point of the HFE (see WO/00 26206).

Useful hydrofluoroethers include two varieties: segregated hydrofluoroethers and omega-hydrofluoroalkylethers. Structurally, the segregated hydrofluoroethers comprise at least one mono-, di-, or trialkoxy-substituted perfluoroalkane, perfluorocycloalkane, perfluorocycloalkyl-containing perfluoroalkane, or perfluorocycloalkylene-containing perfluoroalkane compound.

HFEs suitable for use in the processes of the invention include the following compounds:

C₄F₉OC₂F₄H

HC₃F₆OC₃F₆H

HC₃F₆OCH₃

C₅F₁₁OC₂F₄H

C₆F₁₃OCF₂H

C₆F₁₃OC₂F₄OC₂F₄H

c-C₆F₁₁CF₂OCF₂H

C₃F₇OCH₂F

HCF₂O(C₂F₄O)ₙ(CF₂O)ₘCF₂H, wherein m=0 to 2 and n=0 to 3

C₃F₇O[C(CF₃)₂CF₂O]ₚCFHCF₃, wherein p=0 to 5

C₄F₉OCF₂C(CF₃)₂CF₂H

HCF₂CF₂OCF₂C(CF₃)₂CF₂OC₂F₄H

C₇F₁₅OCFHCF₃

C₈F₁₇OCF₂O(CF₂)₅H

C₈F₁₇OC₂F₄OC₂F₄OC₂F₄OCF₂H

C₄F₉OC₂H₅

C₄F₉OCH₃

C₈F₁₇OCH₃

Preferred HFEs are according to the formula

CₙX₂ₙ₊₁—O—CₘY₂m+1

Wherein X and Y are independently F or H provided that at least one F is present. Preferably, X=F and Y=H; n=2-15 and m=1-10, but preferably, n=3-8 and m=1-4, or more preferably n=4-6 and m=1-3.

Especially preferred is a HFE wherein n=4 and m=1 or 2 which is marketed under the name of HFE 7100™ and 7200™ respectively by the 3M corporation.

Mixtures of different organic dry cleaning solvents may also be used. For example, a suitable dry cleaning composition may comprise a mixture of HFEs together with a mixture of hydrocarbons.

When solvent compounds are mentioned, isomers thereof are also included. Thus, suitable HFEs include nonafluoromethoxybutane (C4F9OCH3) isomers such as 1,1,1,2,2,3,3,4,4-nonafluoro-4-methoxy-butane (CH3OCF2CF2CF2CF3), 1,1,1,2,3,3-hexafluoro-2-(trifluoromethyl)-3-methoxy-propane (CH3OCF2CF(CF3)2), 1,1,1,3,3,3-hexafluoro-2-methoxy-2-(trifluoromethyl)-propane (CH3OC(CF3)3), and 1,1,1,2,3,3,4,4,4-nonafluoro-2-methoxy-butane (CH3OCF(CF3)CF2CF3), approximate isomer boiling point=60° C.; Also isomers of nonafluoroethoxybutane (C4F9OC2H5) such as 1,1,1,2,2,3,3,4,4-nonafluoro-4-ethoxybutane (CH3CH2OCF2CF2CF2CF3), 1,1,1,2,3,3-hexafluoro-2-(trifluoromethyl)-3-ethoxypropane (CH3CH2OCF2CF(CF3)2), 1,1,1,3,3,3-hexafluoro-2-ethoxy-2-(trifluoromethyl)-propane (CH3CH2OC(CF3)3), and 1,1,1,2,3,3,4,4,4-nonafluoro-2-ethoxybutane (CH3CH2OCF(CF3)CF2CF3) with approximate isomer boiling points of 73° C.

Especially suitable solvents are selected from the group consisting of the isomers of nonafluoromethoxybutane, nonafluoroethoxybutane and decafluoropentane and mixtures thereof.

Siloxane Solvents

Another preferred solvent is a siloxane which may be linear, branched, or cyclic, or a combination thereof. Of these linear and cyclic oligo dimethylsiloxanes are preferred. Also preferred is an alkylsiloxane represented by the formula

R₃—Si(—O—SiR₂)_{W}—R

where each R is independently chosen from an alkyl group having form 1 to 10 carbon atoms and w is an integer from 1 to 30. Preferably, R is methyl and w is 1-4 or even more preferably w is 3or 4.

Of the cyclic siloxane octamethyl cyclotetrasiloxane and decamethyl cyclopentasiloxane are particularly effective.

Very useful siloxanes are selected from the group consisting of octamethyltrisiloxane decamethyltetrasiloxane, dodecamethylpentasiloxane and mixtures thereof.

Phthalates, Esters and Terpenes

Phthalates such as dibutyl phthalate, dioctyl phthalate, esters such as C8-C24 saturated and/or unsaturated fatty acid methyl esters, and terpenes, such as limonene, or mixtures of the above may be used. Particularly preferred esters are the C10-C18 fatty acid methyl esters such as methyl laurate, methyl myristate, methyl stearate, methyl linoleate and methyl linolenate and mixtures thereof.

According to one embodiment the less polar liquid is preferably a non-flammable, non-chlorine containing organic solvent. Because of the typical environmental problems associated with chlorine containing solvents, the solvent preferably does not contain Cl atoms, or an even more preferred solvent is halogen free. In addition, the solvent should not be flammable such as most petroleum or mineral spirits having typical flash points as low as 20° C. or even lower. The term non-flammable is intended to describe organic dry cleaning solvents with a flash point of at least 37.8° C., preferably at least 40° C., more preferably at least 45° C., most preferably at least 50° C. The limit of a flashpoint of at least 37.8° C. for non-flammable liquids is defined in NFPA 30, the Flammable and Combustible Liquids Code as issued by National Fire Protection Association, 1996 edition, Massachusetts USA. Preferred test methods for determining the flash point of solvents are the standard tests as described in NFPA30. Although in some case fluoro solvents as described below may be used, in other instances the less polar liquid is preferably halogen free.

The liquid components can be recovered and reused after the cleaning operation.

Fatty Acids and Amines

As previously indicated, fatty acids and fatty amines and mixtures thereof may be incorporated in the liquid composition as optional ingredients, and may be selected from any one or more with carbon chain length ranging from C₁₂ to C₂₂, and preferably with a chain length of C₁₈ to C₂₂. It has been observed that the energy required for agitation may be reduced when fatty acid or amines are incorporated.

Builders

The builders which may be used in the formulation as optional ingredients are preferably inorganic. Suitable builders include, for example, ethylene diamine tetraacetate (EDTA), diethylene triamine pentaacetate (DTPA), sodium tripolyphosphate (STPP), alkali metal aluminosilicates (zeolites), alkali metal carbonate, tetrasodium pyrophosphate (TSPP), citrates, sodium nitrilotriacetate (NTA), and combinations of these. Builders are suitably used in an amount ranging from 0.01-1% by weight.

Salts

The salts which may be used in the formulation as optional ingredients are preferably mineral salts produced by the neutralisation of a mineral acid. Suitable salts include sodium chloride, potassium chloride, lithium chloride, sodium carbonate. Salts may be present at any suitable level up to and including the point where the liquid components are saturated.

Agitation

Agitation may be provided by any suitable means provided for domestic laundering or industrial laundering. The invention is especially suitable for industrial laundering. It is required that thorough mixing of the separate liquid phases is effected and maintained. For example, impellers that provide a vertical flow profile or a radial flow profile can be used. Agitation may also be provided by a rotation and/or tumbling action.

Preferably the agitation time is at least 2 minutes, more preferably at least 5 minutes, and still more preferably at least 15 minutes. Preferably, it is less than 45 minutes, preferably less than 30 minutes, more preferably less than 20 minutes.

Ultrasound

Ultrasound may be applied using any ultrasound source, chosen according to the type of substrate being cleaned and the apparatus and medium of agitation. Preferred are sources with a frequency of from 10 kHz to 10 kHz, e.g. 20 kHz to 100 kHz, and with a power of from 1 to 100 Watts, preferably from 5 to 50 Watts. For some hard surface cleaning applications, a hand-held source may be appropriate.

The Substrate

Substrates which may be cleaned using the process of the invention include textile fabrics, kitchen and bathroom surfaces, industrial surfaces, e.g. in the food industry dishes and cutlery, or indeed any substrate conventionally cleaned using water and detergent.

### EXAMPLES

The invention is further illustrated by the following non-limiting examples, in which parts and percentages are by weight unless otherwise stated.

Pieces of fabric soiled with carbon soot (35 mg gascoal carbon on 20 grams of cotton polyester) or iron oxide (as a model for rust stains; code FeOx) were used throughout this work. For applying ultrasound, a standard ultrasound probe (ex. Vibracell, Sonics and Materials Inc. USA) used at 25 kHz/50 Watt was used, or an ultrasonic bath (ex. Elma, Germany) at 33 kHz/50 Watt. After the wash, the test fabrics were rinsed once in tap water and dried.

Cleaning has been judged by comparing the reflectance of light of 460 nm wavelength of the test fabrics before and after washing.

### Example 1

The four test fabrics (1 g each, 4×4 cm) were immersed in 120 ml of a 75/25 mixture of water and hydrocarbon solvent (DF-2000 solvent from Exxon). In the first experiment agitation was provided for one minute using an ultrasound probe. In a second experiment the test fabrics were immersed in the same mixture in an ultrasonic bath. The test fabrics were agitated for one minute in this bath. A control experiment was done by agitating the test fabrics in a similar mixture in a rotating cylinder for one minute. The reflectance results are given in the following table:

| | Cleaning of MG35 (delta | |
|---|---|---|
| Experiment | R) | Cleaning of FeOx (delta R) |
| Control | 7.8 | 16.2 |
| Ultrasonic probe | 13.2 | 23.4 |
| Ultrasonic bath | 20 | 22.9 |

The experiments using ultrasound lead to significantly better, cleaning.

### Example 2

The test fabrics were immersed in either water or the DF-2000 solvent alone in the ultrasonic bath, followed by ultrasound agitation for one minute. In another experiment the test fabrics were immersed in the water-solvent mixture as described in example 1, followed by agitation in a rotating cylinder for one minute. In yet another experiment the test fabrics were immersed in the ultrasonic bath in the water-solvent mixture as described in example 1, followed by agitation using ultrasound for one minute. The reflectance results are given in the following table:

| | Cleaning of MG35 | Cleaning of FeOx |
|---|---|---|
| Experiment | (delta R) | (delta R) |
| Water only + ultrasound | 10.7 | 19.9 |
| Solvent only + ultrasound | 1.1 | 0.5 |
| Water + solvent, agitation | 7.8 | 16.2 |
| in cylinder | | |
| Water + Solvent, | 20 | 22.9 |
| ultrasound agitation | | |

The results demonstrate the synergistic action of the water-solvent mixture and ultrasound.

### Example 3

The 75/25 mixture of water and hydrocarbon solvent (DF-2000 solvent from Exxon) was first subjected to one minute ultrasound agitation before adding the test fabrics. In the next phase the test fabrics were added to the emulsion. The fabrics with the emulsion were then agitated for one or 15 minutes in the cylinder. A control experiment was done by agitating the test fabrics in the water-solvent mixture in a rotating cylinder also for one or 15 minutes. The reflectance results are given in the following table:

| | Cleaning of MG 35 | Cleaning of MG 35 |
|---|---|---|
| Experiment | (one minute agitation) | (15 minutes agitation) |
| Water-solvent emulsion | 12.1 | 15.1 |
| preparation using | | |
| ultrasound followed by | | |
| washing | | |
| Water-solvent agitation | 7.8 | 11.8 |
| in the cylinder | | |

The process whereby the emulsion is pre-prepared using ultrasound gives a better cleaning result.

### Example 4

The test fabrics were immersed in a 75/25 mixture of water and hydrocarbon solvent (DF-2000 solvent from Exxon). In the first experiment agitation was provided for one minute using an ultrasound probe. In a second experiment the test fabrics were immersed in the same mixture in an ultrasonic bath. The test fabrics were agitated for one minute in this bath. After the experiments the test fabrics were rinsed in water and dried, after which the reflectance could be measured.

A control experiment was done by agitating the test fabrics in a similar mixture in a rotating cylinder for 15 minutes. The reflectance results are given in the following table:

| | Cleaning of MG35 | Cleaning of FeOx |
|---|---|---|
| Experiment | (delta R) | (delta R) |
| Water-solvent 1′ US probe | 13.2 | 23.4 |
| Water-solvent 1′ US bath | 20 | 22.9 |
| Emulsion prepared first by | 12.1 | 14.6 |
| 1′ US agitation followed by | | |
| 1′ wash in the cylinder | | |
| Water-solvent 15′ agitation | 11.8 | 21.0 |
| in cylinder | | |

The results show that using the different methods with ultrasound all give at least as good or better cleaning than the conventional mechanical agitation process, despite the much shorter wash process.

1. A process of cleaning a substrate, the process comprising the steps of contacting a substrate with a composition comprising at least two liquids mutually presenting a liquid-liquid interface with an interfacial tension of at least 5 mN/m and agitating the substrate and/or composition whilst they are in mutual contact, wherein the composition and/or the substrate are also subjected to ultrasound before and/or during the agitation step.

2. A process according to claim 1, wherein the concentration of the most polar liquid in the composition is from 25% to 90% expressed as volume/volume % of the total composition.

3. A process according to claim 1, wherein the liquid-liquid interface has an interfacial tension of at least 8 mN/m.

4. A process according to claim 1, wherein the most polar liquid is water.

5. A process according to claim 1, wherein the less polar liquid has a density of within 10% or less of that of the most polar of the at least two liquids.

6. A process according to any preceding claim, wherein the most polar liquid has a density of within 10% or less of that of the water, with or without any solutes.

7. A process according to claim 1, wherein the less polar liquid comprises a non-flammable, non-chlorine containing organic solvent.

8. A process according to claim 1, wherein the composition comprises as a less polar liquid, a liquid selected from a liquid selected from hydrocarbons, petroleum ether, cycloalkanes, siloxanes, halogenated solvents, fluorinated solvents, phthalates, esters, terpenes and mixtures thereof.

9. A process according to claim 1, wherein the time of agitation is at least 1 minute and less than 45 minutes.

10. A process according to claim 1, carried out in the presence of a compound selected from fatty acids and fatty amines having a carbon chain length of C₁₂ to C₂₂ and mixtures thereof.

11. A process according to claim 1, carried out in the presence of one or more ingredients selected from detergency builders, enzymes, fluorescers, perfumes, anti-redeposition polymers, dye transfer inhibition polymers and soil release polymers.

12. A process according to claim 1, carried out in the presence of a mineral salt.

13. A process according to claim 1, carried out in the absence of hydrogen peroxide.

14. A process according to claim 1, carried out in the absence of a water soluble hypochlorite.

15. A process according to claim 1, carried out in the absence of any bleaching compounds.

16. A process according to claim 1, wherein the substrate is a textile fabric.

17. A process according to claim 1, wherein the substrate is a hard surface, preferably a household surface.

18. A process according to claim 1, wherein the composition comprises less than 0.9 wt % of surfactant by weight of the total composition.

19. A process according to claim 8, wherein the ester is selected from C8-C24 saturated and/or unsaturated fatty acid methyl esters and mixtures thereof.
